(19) United States
(12) Patent Application Publication
(10) Pub. No.: US 2005/0093311 A1
(43) Pub. Date: May 5, 2005

(54) Food serving apparatus

(75) Inventors: Terri Webb, Elmhurst, IL (US); Nathaniel Halle, Chanhassen, MN (US)

Correspondence Address: NEAL, GERBER, & EISENBERG, SUITE 2200, 2 NORTH LASALLE STREET, CHICAGO, IL, 60602, US

(73) Assignee: Columbia Insurance Company, Omaha, NE (US)

(21) Appl. No.: 10/697,425

(22) Filed: Oct. 29, 2003

(51) Int. Cl. A47J 43/28

(52) U.S. Cl. 294/7

(57) ABSTRACT

An apparatus for moving a food item from one surface to another. The apparatus comprises a pair of substantially identical plate members. Each plate member has a generally flat surface formed in the shape of a semi-circle and a handle formed on the semi-circular side of the generally flat surface. The two members may be separately slid under the food item and placed together along their respective first ends to cooperate in forming a base to more easily move the food item from one surface to another surface.

### BACKGROUND OF THE INVENTION

In the field of food preparation and handling, it has long been desirable to provide a means for handling food product without having direct contact between the user and the food product to be consumed. This desire stems from both a sanitary and a practical need. Indirect contact will allow a consumer to eat the meal content in the knowledge that the food will lack any contamination from those who prepared the food. Such indirect contact will also allow a food product provider to handle product he or she might otherwise not be able to handle, such as excessively hot food product or food product that is awkward in shape.

The present invention relates to food serving and preparation devices and in particular to devices used to lift and move such large and awkward products as pizzas, large cookies, other baked goods and the like. It is known to use spatulas and the like to lift and move food products from one surface to the other. Such known designs suffer from several drawbacks. For instance, a spatula has a handle that must support the weight of the food product. In addition, a spatula is designed to lift portions of the food product individually, but not the entire food product as a whole. The use of two separate spatulas for this task can be awkward for the user, and rarely delivers the intended result. Other designs are used to slide members under the food product and lift it from the surface; however, such known designs are not convenient to use in that they are not shaped to fit under a generally circular product such as a pie or pizza and thus do not provide sufficient support to the user.

### SUMMARY OF THE INVENTION

The present invention teaches an improved two piece device that is particularly adapted for handling whole food products of the type generalized by pies, pizzas and the like. The invention comprises a pair of preferably identical members that can be used to slide under the food item at issue and move it from one surface to another or manipulate the food product according to the user's particular need. The two members are semi-circular in shape and cooperate to form a circular, level surface under the food item at issue.

Other benefits and objects of this invention are disclosed herein and will be obvious to readers of ordinary skill in the art. The features disclosed herein can be combined to create a unique design; it should be understood, however, that such features are unique in their own right and can be used independently with other food lifting utensil designs, as will be obvious to one of ordinary skill in the art.

### BRIEF DESCRIPTION OF THE DRAWINGS

FIG. 1 is a top plan view of a pair of lifting plates in accordance with a preferred embodiment of this invention.

FIG. 2 is a top plan view of one of the lifting plates shown in FIG. 1, including an optional measurement feature.

FIG. 3 is a side view of one of the lifting plates shown in FIG. 1.

FIG. 4 is a front view of one of the lifting plates shown in FIG. 1.

FIG. 5 is a perspective view of one of the lifting plates shown in FIG. 1.

FIG. 6 is a top plan view of the pair of lifting plates of FIG. 1, shown in conjunction with an exemplary food product.

### DETAILED DESCRIPTION OF THE DRAWINGS

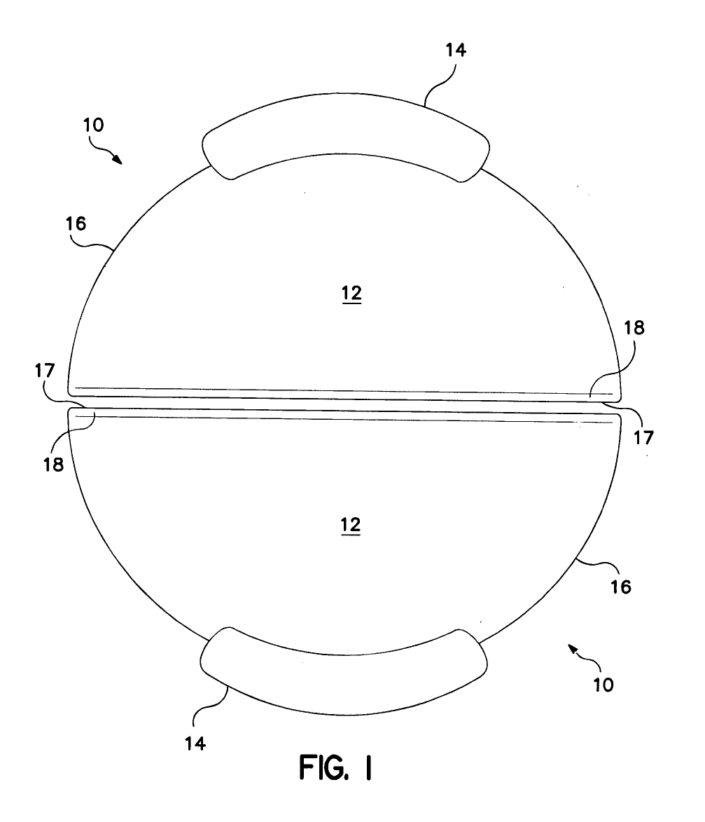

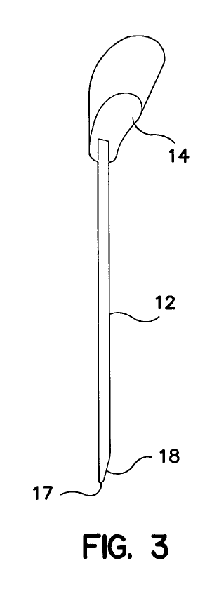

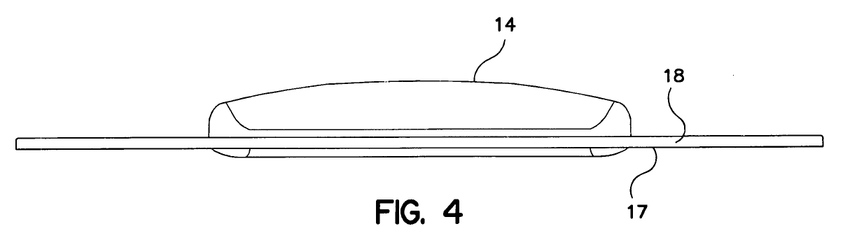

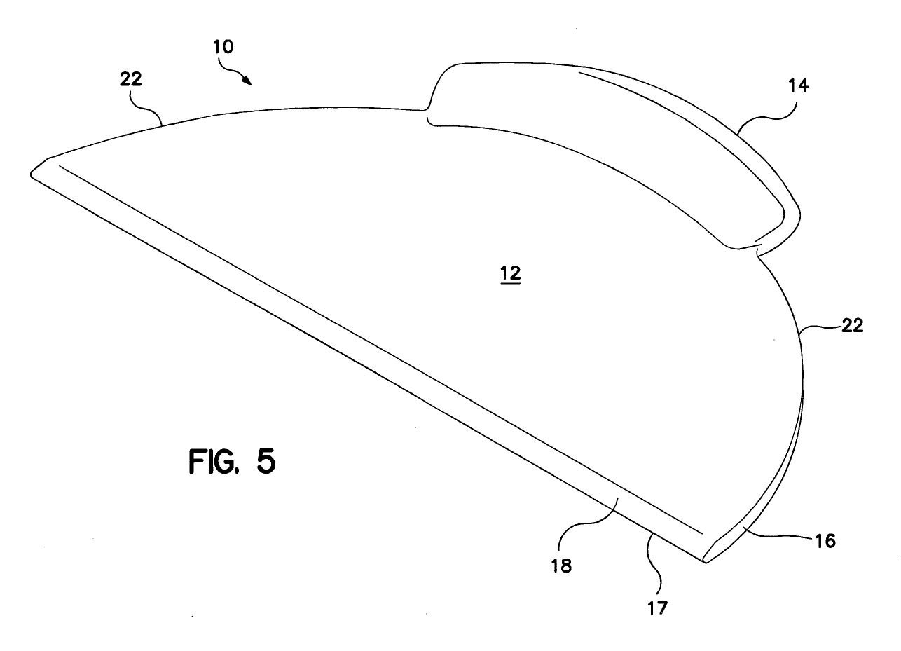

Turning now to the figures, wherein like reference numerals refer to like elements, FIGS. 1 to 6 depict a preferred embodiment of this invention. It will be apparent that the apparatus is best suited to lift or manipulate a food product such as a pizza, cookie, pie or similarly-shaped item. It will be appreciated that the apparatus can be used for a variety of other food products, the common element being that each product has a generally flat base. In FIG. 1, a pair of lifting plates 10 are depicted; for simplicity only one will be described herein. In this preferred embodiment, these two plates are substantially identical. This similitude not only allows a user to more easily lift or manipulate a food product when the two plates are used in conjunction with one another, but also provides for ease in the manufacturing process in that a great many apparatuses may be produced using the same process.

Each plate 10 comprises a generally flat member 12 formed in a semi-circular shape and having a first end 17 formed as a straight edge and a semi-circular side 16. A handle 14 is formed on the semi-circular side 16 and it is preferred that handle 14 be sized to accommodate a typical user's hand. In the preferred embodiment, semi-circular side 16 has two separate arcuate surfaces 22 that are preferably of an equal diameter and which extend from opposite ends of straight edge first end 17 to handle 14, so that the arcuate surfaces 22 and handle 14 together form the semi-circular side 16. A beveled surface 18 is formed on the top side of flat member 12, terminating at first end 17 to permit plate 10 to be easily slid under the food product in question.

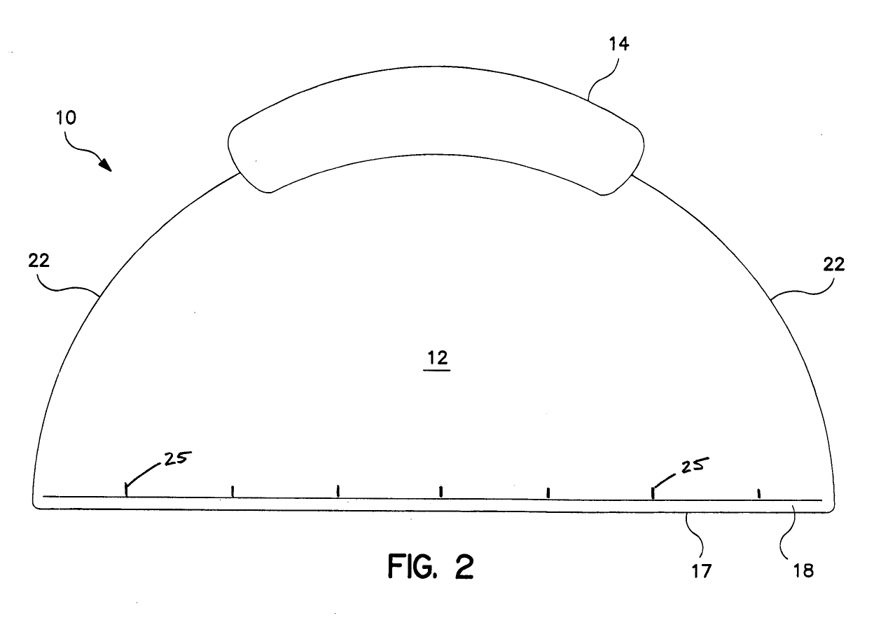

Member 12 is preferably composed of glass-reinforced nylon and the handle 14 is preferably integrally formed therewith. An optional measuring feature consisting of indicia 25 is shown in FIG. 2, and can be formed on or otherwise marked on the top surface of member 12 adjacent to beveled surface 18 for measuring purposes. The size and spacing of indicia 25 can vary depending on the desired uses of the product.

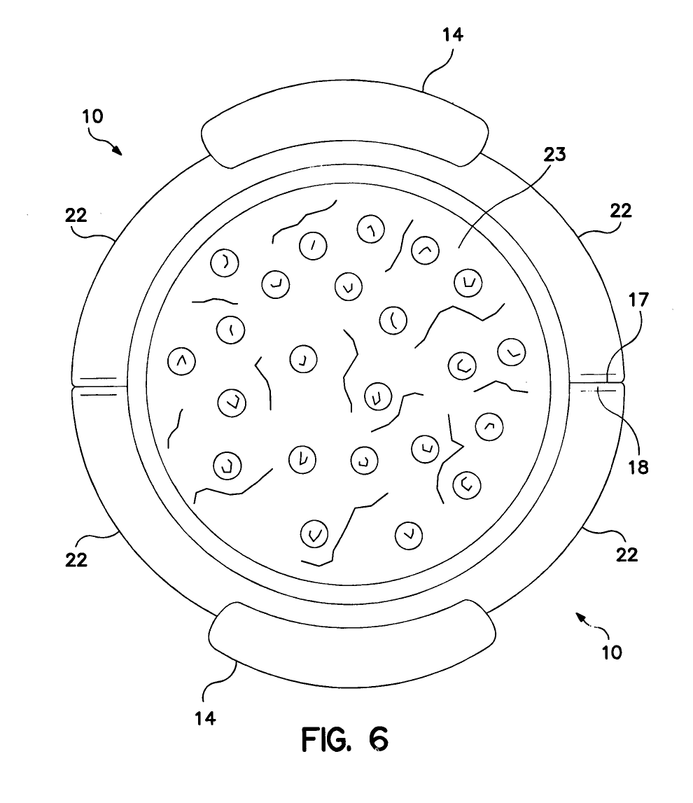

Each plate 10 is preferably sized to fit under a typical food item 23, as shown in FIG. 6. The thickness of each plate 10 is preferably approximately 4 mm. and the bevel would preferably be approximately 15.75 degrees so that the thickness of the plate at edge 17 is approximately 1.25 mm. Straight edge 17 would preferably be 12 inches in length. These sizes enable the user to slide each piece 10 under food item 23, forming a substantial base which aids the user in more easily lifting the food product from a first surface to moving it to a second surface. It will be readily understood, however, that different sizes could easily be used within the spirit and scope of this invention.

While specific embodiments of the invention have been described in detail, it will be appreciated by those skilled in the art that various modifications and alternatives to those details could be developed in light of the overall teachings of the disclosure. Accordingly, the particular arrangement disclosed is meant to be illustrative only and not limiting as to the scope of the invention which is to be given the full breadth of the appended claims and any equivalents thereof.

1. An apparatus for moving a food item from one surface to another, comprising:
a pair of substantially identical members, where each member comprises a generally flat surface having a top and a bottom, a straight edge formed at a first side of the generally flat surface, the straight edge having a first end and a second end, a handle located on a second side of the generally flat surface opposite to the first side, a first arcuate surface extending between the first end of the straight edge and the handle and a second arcuate surface extending between the second end of the straight edge and the handle;
wherein the two members may be separately slid under the food item and placed together along their respective straight edges to cooperate in forming a base to more easily move the food item from one surface to another surface.

2. The apparatus as set forth in claim 1, wherein the radii of the first and second arcuate surfaces as measured from the center of the straight edge are equal.

3. The apparatus as set forth in claim 2, wherein the handle is integrally formed on each member and each handle is sized to accommodate a typical user's hand.

4. The apparatus as set forth in claim 1, wherein the generally flat surface has a thickness of approximately 4 mm.

5. The apparatus as set forth in claim 3, wherein the apparatus is composed of glass-reinforced nylon.

6. The apparatus as set forth in claim 1, further comprising a beveled surface formed on the top of the generally flat surface of each member and extending the length of the straight edge.

7. The apparatus as set forth in claim 6, wherein the bevel begins with a thickness equal to that of the generally flat surface, and terminates at the first end with a thickness of approximately 1.25 mm.

8. The apparatus as set forth in claim 1, further comprising measuring indicia marked on the generally flat surface.

9. An apparatus for moving a food item from one surface to another, comprising:
a pair of substantially identical members, where each member comprises:
a flat surface formed generally in the shape of a semi-circle and having a top, a bottom, a first straight edge and an arcuate side connecting the two ends of the straight edge; and
a handle formed on the arcuate side of the generally flat surface;
wherein the two members may be separately slid under the food item and placed together along their respective first ends to cooperate in forming a base to more easily move the food item from one surface to another surface.

10. The apparatus as set forth in claim 9, wherein the generally flat surface has a thickness of approximately 4 mm.

11. The apparatus as set forth in claim 9, wherein the center of each handle is radially perpendicular to the straight edge of its generally flat surface.

12. The apparatus as set forth in claim 9, wherein the apparatus is composed of glass-reinforced nylon.

13. The apparatus as set forth in claim 9, further comprising a beveled surface formed on the straight edge.

14. The apparatus as set forth in claim 13, further comprising measuring indicia marked on the generally flat surface adjacent to the beveled surface.
